(19) United States
(12) Patent Application Publication
(10) Pub. No.: US 2004/0236553 A1
(43) Pub. Date: Nov. 25, 2004

(54) Three-dimensional tooth orientation for roller cone bits

(76) Inventors: Shilin Chen, The Woodlands, TX (US); James Dahlem, Midlothian, TX (US)

Correspondence Address: ROBERT GROOVER III, Groover & Holmes, Box 802889, DALLAS, TX, 75380-2889, US

(21) Appl. No.: 10/772,225

(22) Filed: Feb. 4, 2004

Related U.S. Application Data
(63) Continuation-in-part of application No. 09/833,016, filed on Apr. 10, 2001.
Application No. 09/833,016 is a continuation of application No. 09/387,737, filed on Aug. 31, 1999, now Pat. No. 6,213,225.
(63) Continuation-in-part of application No. 10/189,305, filed on Jul. 2, 2002.
Application No. 10/189,305 is a continuation of application No. 09/629,344, filed on Aug. 1, 2000, now Pat. No. 6,412,577.
Application No. 09/629,344 is a continuation of application No. 09/387,304, filed on Aug. 31, 1999, now Pat. No. 6,095,262.
(60) Provisional application No. 60/098,466, filed on Aug. 31, 1998.
(60) Provisional application No. 60/098,442, filed on Aug. 31, 1998.
(60) Provisional application No. 60/474,671, filed on May 30, 2003.
(60) Provisional application No. 60/474,672, filed on May 30, 2003.

(51) Int. Cl. G06G 7/48

(52) U.S. Cl. 703/10

(57) ABSTRACT

The present application describes bit design methods (and corresponding bits, drilling methods, and systems) in which the three-dimensional trajectory of an individual tooth cutting into the formation can be obtained and visualized from computer drilling simulator. In order to improve the drilling efficiency of each tooth, it is necessary to orient the tooth three-dimensionally in such a way that its longer crest is perpendicular to the scraping direction, and the top part of the tooth is angled to follow the indentation direction. Such a three-dimensional orientation allows the stress across the surface of the tooth to be more uniformly distributed, thereby, reducing breakage of the tooth.

### CROSS-REFERENCE TO RELATED APPLICATIONS

This application claims priority from U.S. Nonprovisional application Ser. No. 09/833,016 filed Apr. 10, 2001, and therethrough from U.S. Nonprovisional application Ser. No. 09/387,737 filed Aug. 31, 1999 and now issued as U.S. Pat. No. 6,213,225, and therethrough from provisional 60/098,466 filed Aug. 31, 1998.

This application also claims priority from provisional 60/474,671 filed May 30, 2003.

This application also claims priority from provisional 60/474,672 filed May 30, 2003.

This application also claims priority from U.S. Nonprovisional application Ser. No. 10/189,305 filed Jul. 2, 2002, therethrough from U.S. Nonprovisional application Ser. No. 09/629,344 filed Aug. 1, 2000 and now issued as U.S. Pat. No. 6,412,577, and therethrough from U.S. Nonprovisional application Ser. No. 09/387,304 filed Aug. 31, 1999 and now issued as U.S. Pat. No. 6,095,262, and therethrough from provisional 60/098,442 filed Aug. 31, 1998.

### BACKGROUND AND SUMMARY OF THE INVENTION

The present invention relates generally to the drilling of oil and gas wells, or similar drilling operations, and in particular to orientation of tooth angles on a roller cone drill bit.

Background: Rotary Drilling

Oil wells and gas wells are drilled by a process of rotary drilling, using a drill rig such as is shown in FIG. 1. In conventional vertical drilling, a drill bit 10 is mounted on the end of a drill string 12 (drill pipe plus drill collars), which may be more than a mile long, while at the surface a rotary drive (not shown) turns the drill string, including the bit at the bottom of the hole.

Two main types of drill bits are in use, one being the roller cone bit, an example of which is seen in FIG. 2. In this bit, a set of cones 16 (two are visible) having teeth or cutting inserts 18 are arranged on rugged bearings on the arms of the bit. As the drill string is rotated, the cones will roll on the bottom of the hole, and the teeth or cutting inserts will crush the formation beneath them. (The broken fragments of rock are swept uphole by the flow of drilling fluid.) The second type of drill bit is a drag bit, having no moving parts, seen in FIG. 3.

Drag bits are becoming increasingly popular for drilling soft and medium formations, but roller cone bits are still very popular, especially for drilling medium and medium-hard rock. There are various types of roller cone bits: insert-type bits, which are normally used for drilling harder formations, will have teeth of tungsten carbide or some other hard material mounted on their cones. As the drill string rotates and the cones roll along the bottom of the hole, the individual hard teeth will induce compressive failure in the formation.

The bit's teeth must crush or cut rock, with the necessary forces supplied by the “weight on bit” (WOB) which presses the bit down into the rock, and by the torque applied at the rotary drive. While the WOB may in some cases be 100,000 pounds or more, the forces actually seen at the drill bit are not constant: the rock being cut may have harder and softer portions (and may break unevenly), and the drill string itself can oscillate in many different modes. Thus, the drill bit must be able to operate for long periods under high stresses in a remote environment.

When the bit wears out or breaks during drilling, it must be brought up out of the hole. This requires a process called “tripping”: a heavy hoist pulls the entire drill string out of the hole, in stages of (for example) about ninety feet at a time. After each stage of lifting, one “stand” of pipe is unscrewed and laid aside for reassembly (while the weight of the drill string is temporarily supported by another mechanism). Since the total weight of the drill string may be hundreds of tons, and the length of the drill string may be tens of thousands of feet, this is not a trivial job. One trip can require tens of hours and is a significant expense in the drilling budget. To resume drilling, the entire process must be reversed. Thus, the bit's durability is very important to minimize round trips for bit replacement during drilling.

Background: Drill String Oscillation

The individual elements of a drill string appear heavy and rigid. However, in the complete drill string (which can be more than a mile long), the individual elements are quite flexible enough to allow oscillation at frequencies near the rotary speed. In fact, many different modes of oscillation are possible. (A simple demonstration of modes of oscillation can be done by twirling a piece of rope or chain: the rope can be twirled in a flat slow circle, or, at faster speeds, so that it appears to cross itself one or more times.) The drill string is actually a much more complex system than a hanging rope and can oscillate in many different ways; see WAVE PROPAGATION IN PETROLEUM ENGINEERING, Wilson C. Chin, (1994).

The oscillations are damped somewhat by the drilling mud, or by friction where the drill pipe rubs against the walls, or by the energy absorbed in fracturing the formation: but often these sources of damping are not enough to prevent oscillation. Since these oscillations occur down in the wellbore, they can be hard to detect, but they are generally undesirable. Drill string oscillations change the instantaneous force on the bit, and that means that the bit will not operate as designed. For example, the bit may drill oversize, or off-center, or may wear out much sooner than expected. Oscillations are hard to predict since different mechanical forces can combine to produce “coupled modes”; the problems of gyration and whirl are an example of this.

Background: Roller Cone Bit Design

The “cones” in a roller cone bit need not be perfectly conical (nor perfectly frustroconical), but often have a slightly swollen axial profile. Moreover, the axes of the cones do not have to intersect the centerline of the borehole. (The angular difference is referred to as the “offset” angle.) Another variable is the angle by which the centerline of the bearings intersects the horizontal plane of the bottom of the hole, and this angle is known as the journal angle. Thus, as the drill bit is rotated, the cones typically do not roll true, and a certain amount of gouging and scraping takes place. The gouging and scraping action is complex in nature and varies in magnitude and direction depending on a number of variables.

Conventional roller cone bits can be divided into two broad categories: insert bits and steel-tooth bits. Steel tooth bits are utilized most frequently in softer formation drilling, whereas insert bits are utilized most frequently in medium and hard formation drilling.

Steel-tooth bits have steel teeth formed integral to the cone. (A hardmetal is typically applied to the surface of the teeth to improve the wear resistance of the structure.) Insert bits have very hard inserts (e.g., specially selected grades of tungsten carbide) pressed into holes drilled into the cone surfaces. The inserts extend outwardly beyond the surface of the cones to form the “teeth” that comprise the cutting structures of the drill bit.

The design parameters of the component elements in a rock bit are interrelated (together with the size limitations imposed by the overall diameter of the bit), and some of the design parameters are driven by the intended use of the product. For example, cone angle and offset can be modified to increase or decrease the amount of bottom hole scraping. Many other design parameters are limited in that an increase in one parameter may necessarily result in a decrease of another. For example, increases in tooth length may cause interference with the adjacent cones.

Background: Tooth Design

The teeth of steel tooth bits are predominantly of the inverted “V” shape. The included angle (i.e., the sharpness of the tip) and the length of the tooth will vary with the design of the bit. In bits designed for harder formations, the teeth will be shorter, and the included angle will be greater. Heel row teeth (i.e., the teeth in the outermost row of the cone, next to the outer diameter of the borehole) may have a “T” shaped crest for additional wear resistance.

The most common shapes of inserts are spherical, conical, and chisel. Spherical inserts have a very small protrusion and are used for drilling the hardest formations. Conical inserts have a greater protrusion and a natural resistance to breakage, and are often used for drilling medium hard formations.

Chisel shaped inserts have opposing flats and a broad elongated crest, resembling the teeth of a steel tooth bit. Chisel shaped inserts are used for drilling soft to medium formations. The elongated crest of the chisel insert is normally oriented in alignment with the axis of cone rotation. Thus, unlike spherical and conical inserts, the chisel insert may be directionally oriented about its center axis. (This is true of any tooth which is not axially symmetric.) The axial angle of orientation is measured from the plane intersecting the center of the cone and the center of the tooth.

Background: Rock Mechanics and Formations

There are many factors that determine the drillability of a formation. These include, for example, compressive strength, hardness and/or abrasivity, elasticity, mineral content (stickiness), permeability, porosity, fluid content and interstitial pressure, and state of underground stress.

Soft formations were originally drilled with “fish-tail” drag bits, which sheared the formation away. Roller cone bits designed for drilling soft formations are designed to maximize the gouging and scraping action. To accomplish this, cones are offset to induce the largest allowable deviation from rolling on their true centers. Journal angles are small, and cone-profile angles will have relatively large variations. Teeth are long, sharp, and widely-spaced to allow for the greatest possible penetration. Drilling in soft formations is characterized by low weight and high rotary speeds.

Hard formations are drilled by applying high weights on the drill bits and crushing the formation in compressive failure. The rock will fail when the applied load exceeds the strength of the rock. Roller cone bits designed for drilling hard formations are designed to roll as close as possible to a true roll, with little gouging or scraping action. Offset will be zero, and journal angles will be higher. Teeth are short and closely spaced to prevent breakage under the high loads. Drilling in hard formations is characterized by high weight and low rotary speeds.

Medium formations are drilled by combining the features of soft and hard formation bits. The rock breaks away (is failed) by combining compressive forces with limited shearing and gouging action that is achieved by designing drill bits with a moderate amount of offset. Tooth length is designed for medium extensions as well. Drilling in medium formations is most often done with weights and rotary speeds between that of the hard and soft formations. Area drilling practices are evaluated to determine the optimum combinations.

Background: Roller Cone Bit Interaction with the Formation

In addition to improving drilling efficiency, the study of bottom hole patterns has allowed engineers to prevent detrimental phenomena, such as those known as tracking and gyration. The impressions that a tooth makes into the formation depend largely on the design of the tooth, the tangential and radial scraping motions of the tooth, the force and speed with which the tooth impacts the formation, and the characteristics of the formation. Tracking occurs when the teeth of a drill bit fall into the impressions in the formation formed by other teeth at a preceding moment in time during the revolution of the drill bit. Gyration occurs when a drill bit fails to drill on-center. Both phenomena result in slow rates of penetration, detrimental wear of the cutting structures, and premature failure of bits. Other detrimental conditions include excessive uncut rings in the bottom hole pattern. This condition can cause gyration and result in slow rates of penetration, detrimental wear of the cutting structures, and premature failure of the bits. Another detrimental phenomenon is bit lateral vibration, which can be caused by radial force imbalances, bit mass imbalance, and bit/formation interaction among other things. This condition includes directional reversals and gyration about the hole center often known as whirl. Lateral vibration results in poor bit performance, overgage hole drilling, out-of-round, or “lobed” wellbores, and premature failure of both the cutting structures and bearing systems of bits. (Kenner and Isbell, DYNAMIC ANALYSIS REVEALS STABILITY OF ROLLER CONE ROCK BITS, SPE 28314, 1994).

Background: Bit Design

Currently, roller cone bit designs remain the result of generations of modifications made to original designs. The modifications are based on years of experience in evaluating bit records, dull bit conditions, and bottom hole patterns.

One method commonly used to discourage bit tracking is known as a staggered tooth design. In this design, the teeth are located at unequal intervals along the circumference of the cone. This is intended to interrupt the recurrent pattern of impressions on the bottom of the hole. Examples of this are shown in U.S. Pat. No. 4,187,922 and UK application 2,241,266.

Background: Shortcomings of Existing Bit Designs

The economics of drilling a well are strongly reliant on rate of penetration. Since the design of the cutting structure of a drill bit controls the bit's ability to achieve a high rate of penetration, cutting structure design plays a significant role in the overall economics of drilling a well. Prior to the parent applications, current bit designs have not solved the issue of tracking. Complex mathematical models can simulate bottom hole patterns to a limited extent, but they do not suggest a solution to the ever-present problem of tracking. The known angular orientations of teeth designed to improve tooth impact strength leave excessive uncut bottom hole patterns and do not solve the problem of tracking. The known angular orientations of teeth designed to increase bottom hole coverage, fail to optimize tooth orientation and do not solve the problem of tracking. Staggered tooth designs do not prevent tracking of the outermost rows of teeth. On the outermost rows of each cone, the teeth are encountering impressions in the formation left by teeth on other cones. The staggered teeth are just as likely to track an impression as any other tooth. Another disadvantage to staggered designs is that they may cause fluctuations in cone rotational speed, resulting in fluctuations in tooth impact force and increased bit vibration. Bit vibration is very harmful to the life of the bit and the life of the entire drill string.

Background: Cutting Structure Design

In the publication A NEW WAY TO CHARACTERIZE THE GOUGING-SCRAPING ACTION OF ROLLER CONE BITS (Ma, Society of Petroleum Engineers No. 19448, 1989), the author determines that a tooth in the first row of the drill bit evaluated contacts the formation at −22 degrees (measured with respect to rotation of the cone about its journal) and begins to separate at an angle of −6 degrees. The author determines that the contacting range for the second row of the same cone is from −26 degrees to 6 degrees. The author states that “because the crest of the chisel inserts are always in the parallel direction with the generatrix of the roller cone . . . radial scraping will affect the sweep area only slightly.” The author concludes that scraping distance is a more important than the velocity of the cutter in determining performance.

In U.S. Pat. No. 5,197,555, Estes discloses a roller cone bit having opposite angular axial orientation of chisel shaped inserts in the first and second rows of a cone. This invention is premised on the determination that inserts scrape diagonally inboard and either to the leading side (facing in the direction of rotation) or to the trailing side (facing opposite to the direction of rotation). It is noted that the heel row inserts engage the formation to the leading side, while the second row inserts engage the formation to the trailing edge. In one embodiment, the inserts in the heel row are axially oriented at an angle between 30 degrees and 60 degrees, while the inserts in the second row are axially oriented between 300 degrees and 330 degrees. This orientation is designed to provide the inserts with a higher resistance to breakage. In an alternative embodiment, the inserts in the heel row are oriented at an axial angle between 300 degrees and 330 degrees, while the inserts in the second row are axially oriented between 30 degrees and 60 degrees. This orientation is designed to provide the inserts with a broader contact area with the formation for increased formation removal, and thereby an increased rate of penetration of the drill bit into the formation.

In U.S. Pat. No. 4,108,260, Bozarth discloses a special shaped insert with asymmetrical flanks. The leading flank is scoop-shaped, and the trailing flank is rounded outwardly. The scoop-shaped leading flank aids in lifting cuttings, and the convex trailing flank increases the insert strength.

In U.S. Pat. No. 4,086,973, Keller and Langford disclose an insert having an asymmetric head so that the crest will contact the formation over the entire length of the crest. The loading is more uniformly distributed on the crest length so chipping and breaking of insert may be avoided.

In U.S. Pat. No. 5,027,913, Nguyen suggests to orient each insert such that the insert has an attack angle with respect to a formation. The centerline of the insert does not intersect the axis of the cone. Each of the insert is, therefore, in a more compressive mode rather than in shear mode as the insert first contacts the formation.

In U.S. Pat. No. 6,161,634, Minikus et al. maximize scraping action and allow greater flexibility in the number of cutter elements used on a drill bit by providing at least one cutter element on the bit with a non-rectilinear crest. The term “non-rectilinear” is used to refer to configurations that are other than straight lines and includes curvilinear crests. Minikus, et al. also disclose the use of cutter elements having non-positive drafts.

Parent case U.S. Pat. No. 6,095,262 describes roller cone drill bit design methods and optimizations whereby the three-dimensional tooth shape, cone profile, cone layout, three-dimensional cone, three-dimensional bit, and two-dimensional hole profile are displayed.

First, the bit geometry, rock properties, and bit operational parameters are input. The three-dimensional tooth shape, cone profile, cone layout, three-dimensional cone, three-dimensional bit, and two-dimensional hole profile are then displayed. Since there are two types of rotation relevant to the calculation of the hole bottom (cone rotation and bit rotation), transformation matrices from cone to bit coordinates must be calculated.

The number of bit revolutions is input, and each cone is counted, followed by each row of teeth for each cone. Next, the type of teeth of each row is identified, and the teeth are counted. Next, a time interval delta is set, and the position of each tooth is calculated at this time interval. If a given tooth is not “cutting” (i.e., in contact with the hole bottom), then the algorithm continues counting until a cutting tooth is reached. The tooth trajectory, speed, scraping distance, crater distribution, coverage ratio and tracking ratios for all rows, cones, and the bit are then calculated. This section of the process gives the teeth motion over the hole bottom and displays the results.

Next, the bit mechanics are calculated. Again transformation matrices from cone to bit coordinates are calculated, and the number of bit revolutions and maximum time steps, delta, are input. The cones are then counted, the bit and cone rotation angles are calculated at the given time step, and the rows are counted. Next, the three-dimensional tooth surface matrices for the teeth on a given row are calculated. The teeth are then counted, and the three-dimensional position of the tooth on the hole bottom is calculated at the given time interval. If a tooth is not cutting, counting continues until a cutting tooth is reached. The cutting depth, area, volume and forces for each tooth are calculated, and the hole bottom model is updated (based on the crater model for the type of rock being drilled). Next, the number of teeth cutting at any given time step is counted. The tooth force is then projected into cone and bit coordinates, yielding the total cone and bit forces and moments. Finally, the specific energy of the bit is calculated. Finally, all results are outputted. The process can then be reiterated if needed.

The teachings of U.S. Pat. No. 6,095,262 are hereby incorporated by reference.

Three-Dimensional Tooth Orientation for Roller Cone Bits

The present application teaches that simulation of the three-dimensional trajectories of individual teeth through the bottom hole profile can be used to optimize orientation of the axis of the tooth tip. With insert teeth this can be done by changing the orientation of the shank, or by using a tooth whose tip has a principal axis (e.g., axis of highest compressive failure strength for a given formation hardness) which is not aligned with the axis of the insert shank.

The present application teaches that simulation of the three-dimensional trajectories of individual teeth through the bottom hole profile can be used to optimize three directions of orientation of the tooth tip. For example, for a given tooth position within a given row of a given cone, the tooth can be rotated around its base axis an angle (orientation angle or rotation angle) in order to keep the elongated crest perpendicular to the scraping direction. An axis of the tooth tip can be then tilted toward or away from the cone axis (“azimuth tilt angle”), and can also be tilted forward or backward in the row circle (“rake angle”).

If the top surface of a tooth is a plane, the tip axis is the normal vector of this plane. Most of the chisel inserts and steel teeth belong to this case. Otherwise, the simulator is able to determine which zone within the top surface of a tooth is actually in cutting with the formation. Then the geometric center of this cutting zone may be determined. The tip axis is referenced to be the normal vector of this center point.

It is possible that the efficiency of compressive failure will be slightly higher, at least before the tooth is fully engaged with the rock. If the zone of active failure (around the edge of the conical tooth) is more nearly equidistant from the point of maximum strain (at the tooth tip), rock failure will be more efficient. Therefore, before the tooth is fully engaged with the rock, the actual contacting area is smaller, so the actual stress applied to the formation is larger.

If the tooth axis of a symmetric tooth is aligned with the trajectory during the entry phase, lateral forces on the tooth would be more nearly balanced during the entry phase. Thereby, reducing chipping of the tooth. Also, drilling efficiency will be improved because more compressive stress will be applied to the rock.

The present application teaches that simulation of the three-dimensional trajectories of individual teeth through the bottom hole profile can be used to optimize both: 1) tooth compressive strength which should be aligned with compressive stress during the entry phase of the trajectory; and 2) cantilever strength which can be aligned with the maximum bending moment expected during the exit phase of the tooth trajectory.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 shows a drill rig in which bits optimized by the teachings of the present application can be advantageously employed.

FIG. 2 shows a conventional roller cone bit, and FIG. 3 shows a conventional drag bit.

FIG. 4 shows a sample embodiment of a steel tooth bit, using the teachings of the present application.

FIGS. 5 and 5A show a sample embodiment of an insert bit, using the teachings of the present application.

FIG. 6 depicts the angles of rotation for a sample tooth bit on an XYZ plot.

FIG. 7 depicts, on a ZR plot, the EF part of the vertical plane of the projection of the cutting path or trajectory for a sample indentation angle.

FIG. 8 depicts, on an XY plot, the EF part of the horizontal plane of the projection of the cutting path or trajectory for a sample orientation angle.

FIG. 9 shows the penetration direction in relation to the normal of the surface for two asymmetric teeth.

FIG. 10 shows the correlation of a tooth crest to the scraping direction.

FIG. 11 shows the correlation of the tooth crest to the indentation direction.

FIG. 12 shows the correlation between the tooth tip axis and the tooth base axis.

FIG. 13 is a flow chart of the orientation procedure disclosed in the present application.

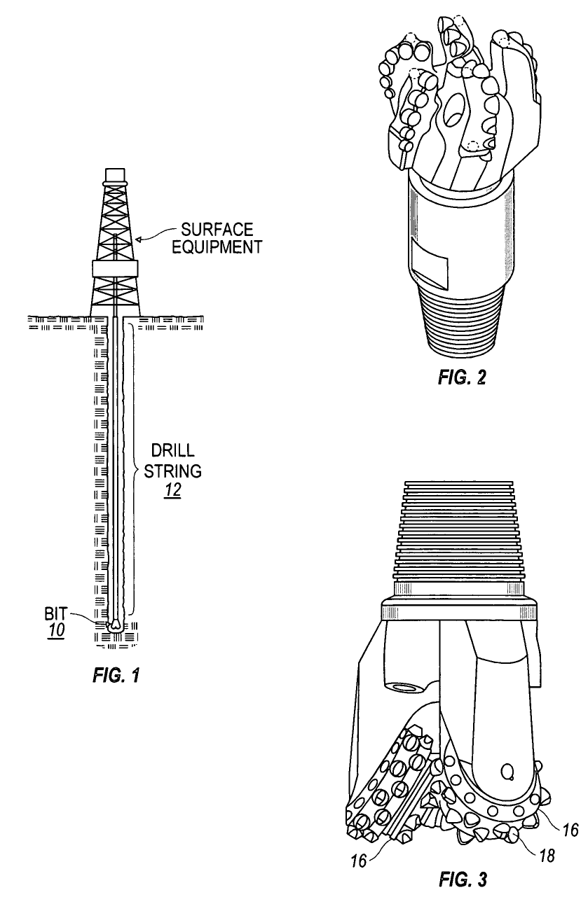

### DETAILED DESCRIPTION OF THE PREFERRED EMBODIMENTS

The numerous innovative teachings of the present application will be described with particular reference to the presently preferred embodiment (by way of example, and not of limitation).

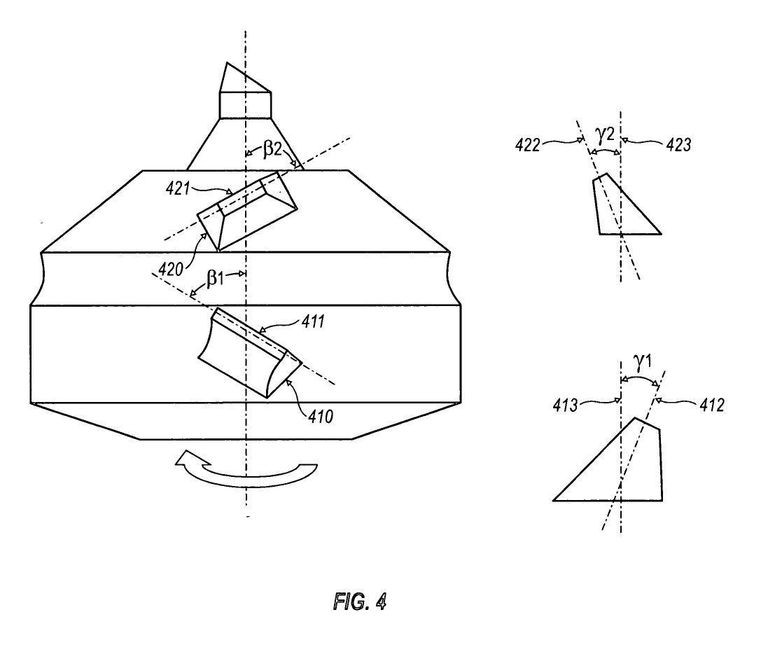

FIG. 4 illustrates an embodiment of the invention. Tooth 410 is first rotated an angle β₁ such that the elongated crest length 411 is perpendicular to the scraping direction, as taught by U.S. Pat. No. 6,095,262. The tooth end face is asymmetric, and the normal of the top crest face 412 has an angle γ₂ with the tooth axis 413.

Tooth 420 is first rotated an angle β₂ such that the elongated crest length 421 is perpendicular to the scraping direction, as taught by U.S. Pat. No. 6,095,262. The tooth end face is asymmetric, and the normal of the top crest face 422 has an angle γ₂ with the tooth axis 423.

In this embodiment, the tooth base axis is perpendicular to the cone surface. This orientation allows the pointing tip to align with the point of maximum stress.

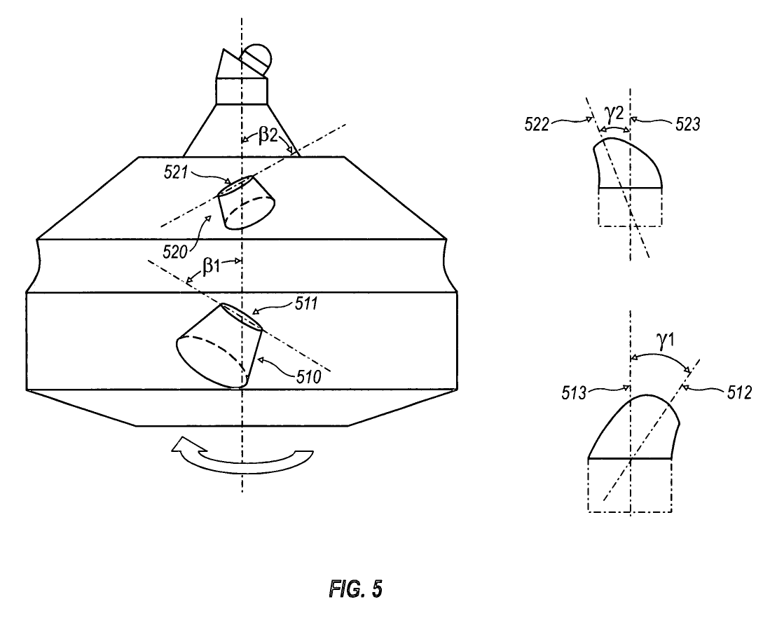

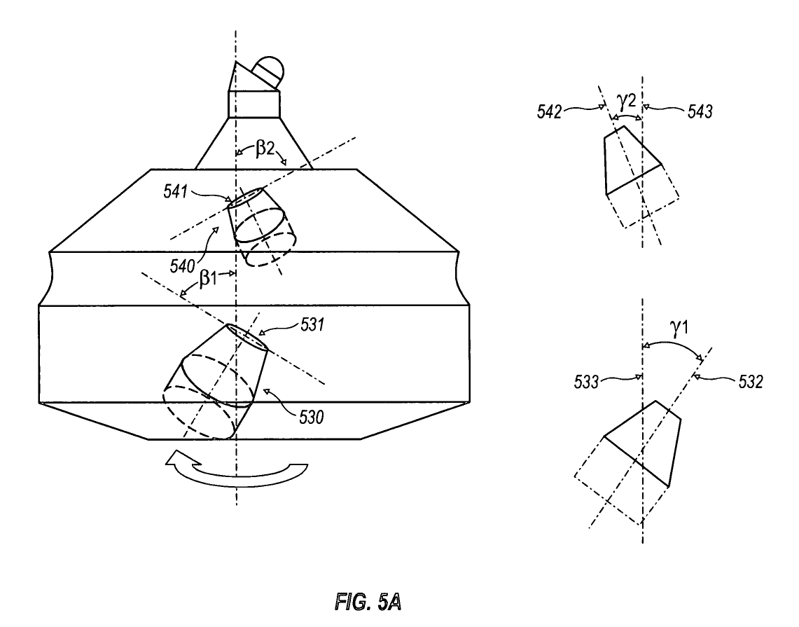

FIG. 5 illustrates an embodiment of the invention. Insert bit 510 is first rotated around its own axis an angle β₁ such that the elongated crest length 511 is perpendicular to the scraping direction. The insert top is asymmetric, and the normal of the crest face 512 has an angle γ₁ with the tooth axis 513.

Insert bit 520 is first rotated around its own axis an angle β₂ such that the elongated crest length 521 is perpendicular to the scraping direction. The insert top is asymmetric, and the normal of the crest face 522 has an angle γ₂ with the tooth axis 523.

Angle β is first determined by the projection of a three-dimensional scraping trajectory to the horizontal plane. Angle γ is then determined by the projection of a three-dimensional scraping path to the plane which passes through the insert axis and is perpendicular to the crest length. Angle γ is determined by the first half of the trajectory, and the normal direction of the crest surface is in line with the tangent of the first half of the trajectory.

In this embodiment, the insert axis is perpendicular to the cone surface in this embodiment. Once again, this orientation allows the pointing tip to align with the point of maximum stress.

FIG. 5A illustrates an alternative embodiment, the base axis and the top axis of an insert may be the same. The insert 530 is first rotated around its own axis an angle β₁ such that the elongated crest length 531 is perpendicular to the scraping direction, as taught by U.S. Pat. No. 6,095,262. The axis of the insert 532 is then tilted toward or away from the cone axis 533 and can also be tilted forward or backward in the plane of row circle which is perpendicular to cone axis such that the insert axis has an angle γ₁ with the cone surface.

The insert 540 is first rotated around its own axis an angle β₂ such that the elongated crest length 541 is perpendicular to the scraping direction, as taught by U.S. Pat. No. 6,095,262. The axis of the insert 542 is then tilted toward or away from the cone axis 543 and can also be tilted forward or backward in the plane of row circle which is perpendicular to cone axis. The insert axis has an angle γ₂ with the cone surface.

Angle γ is determined by the three-dimensional trajectory. In this embodiment, the insert axis is not perpendicular to the cone surface.

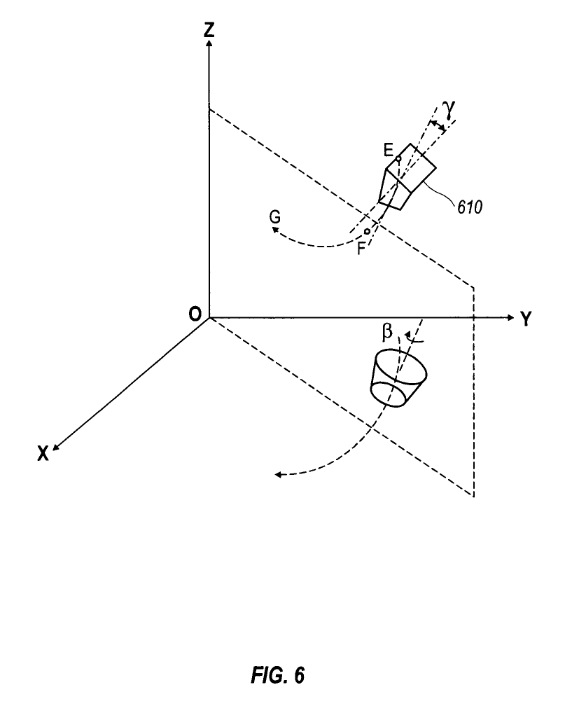

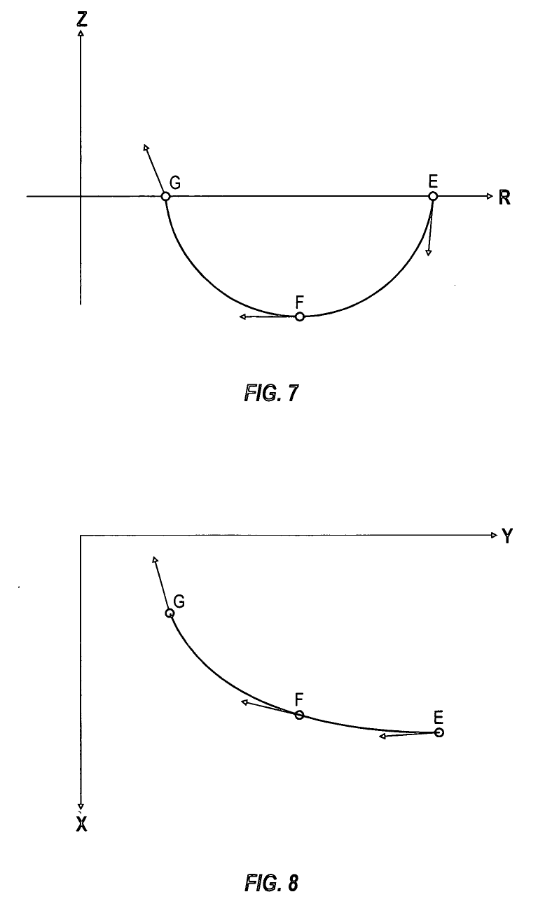

As shown in FIG. 6, the three-dimensional scraping path can be divided into two sections: EF and FG. The effective penetration of tooth 610 into rock is performed within EF. Therefore, the direction of EF is used to calculate angle γ. While angle β may be positive or negative depending on the cone geometry, angle γ is always positive in this preferred embodiment and may be from 0 to 30 degrees, and preferably from 5 to 15 degrees. FIG. 7 shows the ZR plot of the EF part of the projection of a cutting path or trajectory to the vertical plane. The EF part to the vertical plane is used to determine the indentation angle. The indentation angle can be realized by the insert itself or by the hole angle drilled in the cone.

FIG. 8 shows the XY plot of the EF part of the projection of a cutting path or trajectory to the horizontal plane. The EF part to the horizontal plane is used to determine the orientation angle as described in U.S. Pat. No. 6,095,262.

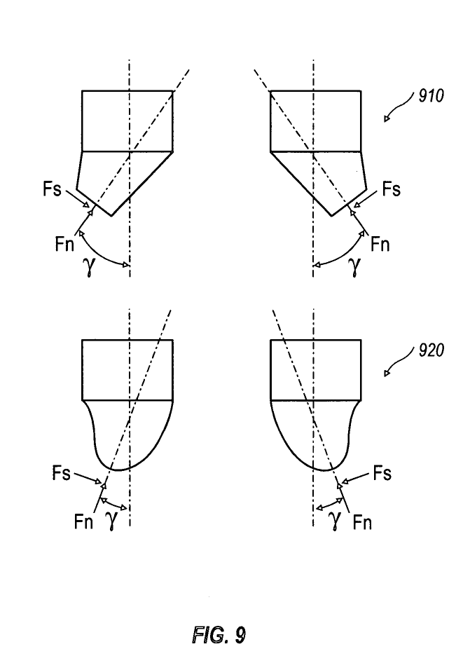

FIG. 9 shows two asymmetric teeth 910 and 920. The normal of the surface is in line with the penetration direction as described by the present application. The advantage of having the normal of the top surface in line with the penetration direction is that stress is more uniformly distributed and the tooth cutting into the formation is more efficient.

Due to the orientation, the side force of the tooth may be larger due to deeply cutting into the formation, but the stress associated with it may be reduced due to the “convex” trailing flank. This results in reduced breakage of the tooth.

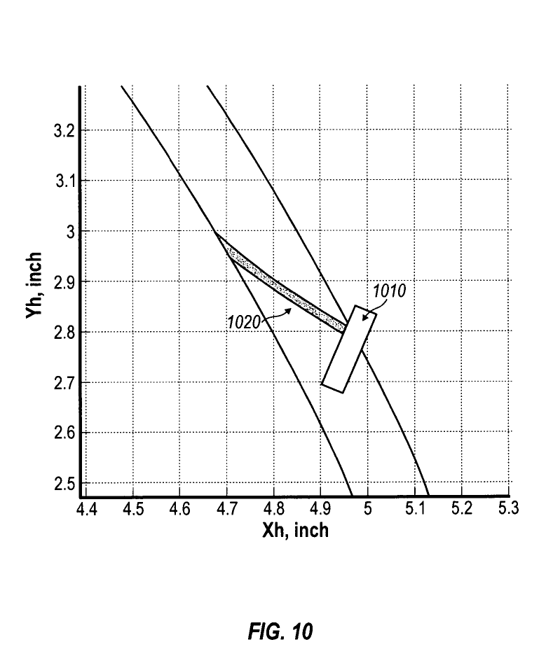

FIG. 10 shows the correlation of tooth crest 1010 of a tooth to the scraping direction 1020 along the XY horizontal plane.

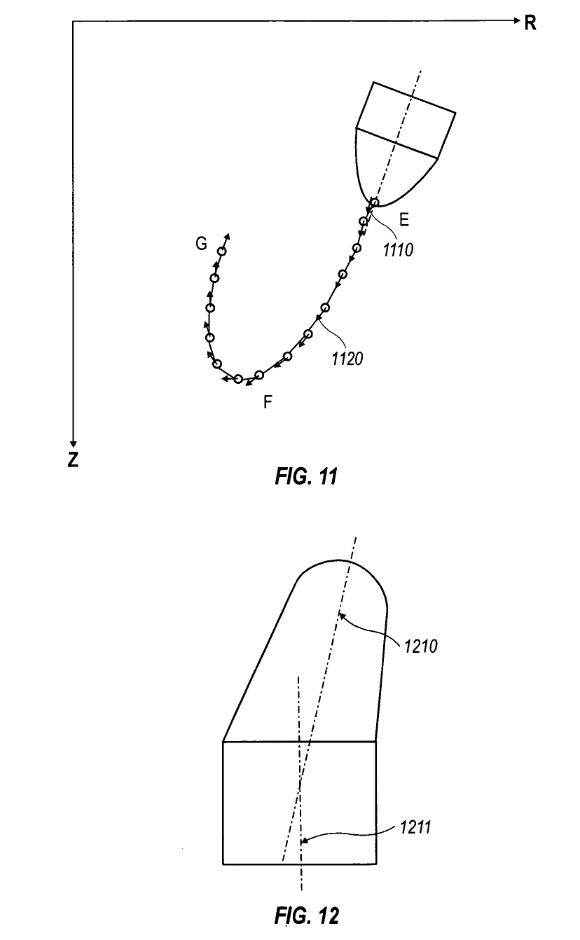

FIG. 11 shows the correlation of the top part 1110 of a tooth to the indentation direction 1120. The scraping path is divided into two parts: EF and FG.

FIG. 12 shows the correlation of tooth tip axis 1210 to the tooth base axis 1211.

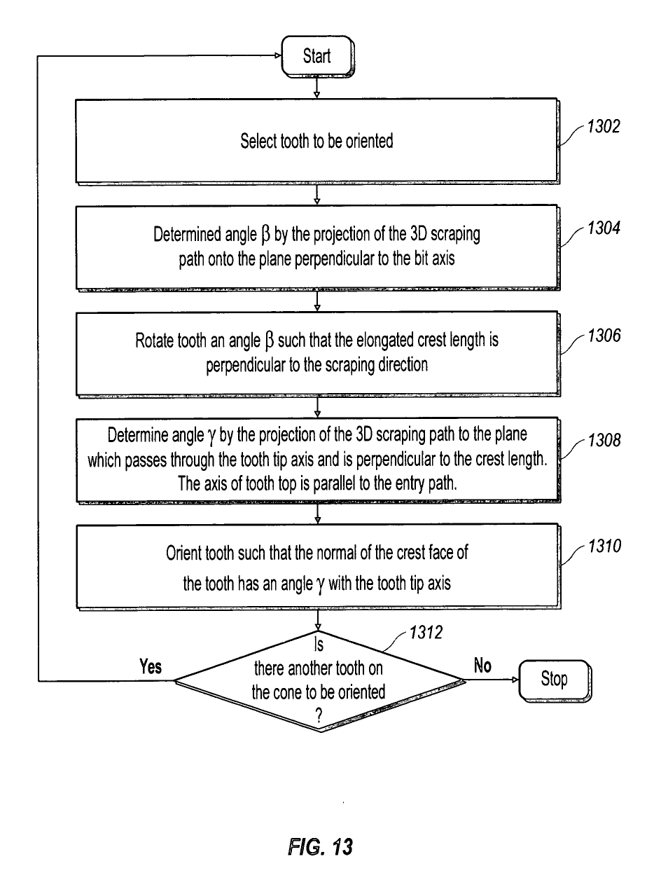

An overview of the design process is shown in FIG. 13. First, the tooth to be oriented is selected (step 1302). Angle β is determined by the projection of the three-dimensional scraping path onto the plane perpendicular to the bit axis (step 1304). The selected tooth is then rotated an angle β such that the elongated crest length is perpendicular to the scraping direction (step 1306). Angle γ is determined by the projection of the three-dimensional scraping path onto the plane which passes through the tooth tip axis and is perpendicular to the crest length (step 1308). At this angle, the axis of the tooth tip is parallel to the entry path. The selected tooth is now oriented such that the normal of the crest face of the tooth has an angle γ with the tooth tip axis (step 1310). If there is another tooth on the cone to be oriented (step 1312), then the entire process is repeated again for that tooth.

Definitions:

Following are short definitions of the usual meanings of some of the technical terms that are used in the present application. (However, those of ordinary skill will recognize whether the context requires a different meaning.) Additional definitions can be found in the standard technical dictionaries and journals.

Trajectory: the sequence of positions and orientations of the tooth as it passes through the rock formation.

Tooth tip axis: a tooth may be divided into two parts: base and top as shown in FIG. 12. Tooth tip is the center point of the zone which is in cutting with the formation (cutting zone). Tooth tip axis is the normal vector of the cutting zone.

According to a disclosed class of innovative embodiments, there is provided: A method for designing a roller-cone earth-penetrating drill bit, comprising the actions of: simulating the unconstrained motion of cones of a roller-cone earth-penetrating drill bit, including the trajectories of teeth thereof through rock being drill; and, for multiple respective ones of said teeth, both adjusting a respective crest orientation, thereof, in accordance with the general direction of the trajectory of said tooth in a plane normal to the wellbore axis, and also adjusting an axis of said tooth in accordance with the angle at which said tooth indents said rock at the start of said indentation of said tooth.

According to a disclosed class of innovative embodiments, there is provided: A method for designing a roller-cone earth-penetrating drill bit, wherein the action of simulating the unconstrained motion of cones of a roller-cone earth-penetrating drill bit includes the three-dimensional trajectories of teeth thereof through rock being drilled.

According to a disclosed class of innovative embodiments, there is provided: A method for designing a roller-cone earth-penetrating drill bit, wherein said bit comprises exactly three of said cones.

According to a disclosed class of innovative embodiments, there is provided: A method for designing a roller-cone earth-penetrating drill bit, wherein said cones have a bulged frustro-conical shape.

According to a disclosed class of innovative embodiments, there is provided: A method for designing a roller-cone earth-penetrating drill bit, wherein said teeth are inserts mounted on the bodies of said cones.

According to a disclosed class of innovative embodiments, there is provided: A method for designing a roller-cone earth-penetrating drill bit, wherein said teeth are formed integrally with the bodies of said cones.

According to a disclosed class of innovative embodiments, there is provided: A method for designing a roller-cone earth-penetrating drill bit, wherein each of said cones differs from the others.

According to a disclosed class of innovative embodiments, there is provided: A method for designing a roller-cone earth-penetrating drill bit, wherein said crests are straight.

According to a disclosed class of innovative embodiments, there is provided: A method for designing a roller-cone earth-penetrating drill bit, wherein said crests have a length which is between one-third and two-thirds of the width of a tooth.

According to a disclosed class of innovative embodiments, there is provided: A method for designing a roller-cone earth-penetrating drill bit, wherein said tooth is symmetric about an axis, and said adjusting step changes said axis.

According to a disclosed class of innovative embodiments, there is provided: A method for designing a roller-cone earth-penetrating drill bit, wherein said tooth has a tip portion which is symmetric about a first axis, and has a root portion which is not symmetric about said first axis, and said adjusting step changes said first axis.

According to a disclosed class of innovative embodiments, there is provided: A method for designing a roller-cone earth-penetrating drill bit, wherein said tooth has a tip portion which is symmetric about a first axis, and has a root portion which is symmetric about a second axis, and said adjusting step changes said first axis.

According to a disclosed class of innovative embodiments, there is provided: A method for designing a roller-cone earth-penetrating drill bit, wherein said crest of at least one tooth intersects said axis thereof.

According to a disclosed class of innovative embodiments, there is provided: A method for designing a roller-cone earth-penetrating drill bit, wherein said crest of at least one tooth does not intersect said axis thereof.

According to a disclosed class of innovative embodiments, there is provided: A method for designing a roller-cone earth-penetrating drill bit, wherein said crest of at least one tooth is perpendicular to said axis thereof.

According to a disclosed class of innovative embodiments, there is provided: A method for designing a roller-cone earth-penetrating drill bit, wherein the angle of the axis varies for the teeth on a single row.

According to another disclosed class of innovative embodiments, there is provided: A method for designing a roller-cone earth-penetrating drill bit, comprising the actions of: fully simulating the motion of a roller-cone earth-penetrating drill bit, including the unconstrained rotation of cones thereof, and the trajectories of teeth supported by said cones through rock being drilled; and, for multiple respective ones of said teeth, both adjusting a respective crest orientation thereof, and also adjusting an axis of said tooth in accordance with the angle at which said tooth indents said rock at the start of said trajectory of said tooth.

According to a disclosed class of innovative embodiments, there is provided: A method for designing a roller-cone earth-penetrating drill bit, wherein two axes of said tooth are adjusted.

According to another disclosed class of innovative embodiments, there is provided: A method for designing a roller-cone earth-penetrating drill bit, comprising the actions of: simulating the trajectories of teeth supported by cones of said drill bit through rock under drilling conditions; and, for multiple respective ones of said teeth, adjusting at least two different orientation angles thereof, said orientation angles being different from parameters which define the characteristics of the respective tooth, and different from parameters which define the location of the respective tooth on the surface of the cone.

According to a disclosed class of innovative embodiments, there is provided: A method for designing a roller-cone earth-penetrating drill bit, wherein at least three different orientation angles are adjusted.

According to another disclosed class of innovative embodiments, there is provided: A method for designing a roller-cone earth-penetrating drill bit, comprising the actions of: simulating the unconstrained motion of cones of a roller-cone earth-penetrating drill bit, including the three-dimensional trajectories of teeth thereof through rock being drilled; and, for at least one of said teeth, adjusting an axis of said tooth in accordance with the angle at which said tooth indents said rock at the start of said trajectory.

According to a disclosed class of innovative embodiments, there is provided: A method for designing a roller-cone earth-penetrating drill bit, wherein said axis of said tooth is adjusted in accordance with the three-dimensional vector at which said tooth indents said rock at the start of said trajectory.

According to another disclosed class of innovative embodiments, there is provided: A method for designing a roller-cone earth-penetrating drill bit, comprising the actions of: simulating the unconstrained motion of cones of a roller-cone earth-penetrating drill bit, including the three-dimensional trajectories of teeth thereof through rock being drilled; and, for at least one of said teeth, adjusting the orientation of the crest length of said tooth; and adjusting the orientation of the top part of said tooth, in dependence on said trajectory.

According to a disclosed class of innovative embodiments, there is provided: A method for designing a roller-cone earth-penetrating drill bit, wherein said crest length is adjusted with respect to the scraping direction of said teeth through rock being drilled, and the top part is adjusted with respect to the indentation direction of said teeth through rock being drilled.

According to a disclosed class of innovative embodiments, there is provided: A method for designing a roller-cone earth-penetrating drill bit, wherein said crest length is adjusted to be perpendicular to the scraping direction of said teeth through rock being drilled, and the top part is adjusted to follow the indentation direction of said teeth through rock being drilled.

According to another disclosed class of innovative embodiments, there is provided: A method for designing a roller-cone earth-penetrating drill bit, comprising the actions of: simulating the unconstrained motion of cones of a roller-cone earth-penetrating drill bit, including the three-dimensional trajectories of teeth thereof through rock being drilled; and, for at least one of said teeth, determining the indentation angle for said teeth, in dependence on said trajectory; and orientating the top part of said tooth with respect to the indentation angle.

According to another disclosed class of innovative embodiments, there is provided: A method for designing a roller-cone earth-penetrating drill bit, comprising the actions of: simulating the unconstrained motion of cones of a roller-cone earth-penetrating drill bit, including the three-dimensional trajectories of teeth thereof through rock being drilled; and, for at least one of said teeth, adjusting said teeth, in dependence on said trajectory; such that the normal of the surface of said teeth is in line with the penetration direction of said teeth through rock being drilled.

According to another disclosed class of innovative embodiments, there is provided: A roller-cone earth-penetrating drill bit comprising: one or more teeth, wherein the crest length is perpendicular to the scraping direction of said teeth through rock being drilled, and the top part follows the indentation direction of said teeth through rock being drilled.

According to another disclosed class of innovative embodiments, there is provided: A roller-cone earth-penetrating drill bit wherein the angle of the axis varies for the teeth on a single row.

According to another disclosed class of innovative embodiments, there is provided: A roller-cone earth-penetrating drill bit comprising: one or more teeth, wherein the normal of the surface of said teeth when said respective teeth first contacts cutting face is in line with the penetration direction of said teeth through rock being drilled.

According to another disclosed class of innovative embodiments, there is provided: A roller-cone earth-penetrating drill bit comprising: one or more teeth with an axis adjusted in accordance with the trajectory of said respective teeth onto a cutting surface.

According to another disclosed class of innovative embodiments, there is provided: A roller-cone earth-penetrating drill bit comprising: one or more teeth with an axis adjusted in accordance with an angle at which said respective teeth penetrates through a cutting surface into a volume of material therebeneath.

According to another disclosed class of innovative embodiments, there is provided: A roller-cone earth-penetrating drill bit comprising: one or more teeth with the crests and the top parts of said respective teeth adjusted in dependence on a three-dimensional trajectory of said respective teeth through formation being drilled.

Modifications and Variations

As will be recognized by those skilled in the art, the innovative concepts described in the present application can be modified and varied over a tremendous range of applications, and accordingly the scope of patented subject matter is not limited by any of the specific exemplary teachings given.

The present application contains a number of further developments which go beyond the parent applications. Some of these are as follows.

Several alternative embodiments are presented for alignment of the tooth tip axis in relation to the expected three-dimensional trajectory of that tooth.

In the presently preferred embodiment, the tooth tip axis is normal to the actual surface of the hole bottom at the point of entry.

In some embodiments, the tooth tip axis is aligned to be parallel with the tangent to the trajectory near the point of entry.

In some embodiments, the tooth tip axis is aligned to be parallel with the average tangent to the trajectory during the entry phase. In these embodiments, the “average tangent to the trajectory” can be calculated as an average with respect to: time; depth; path length; maximum force; or work.

In some embodiments the tooth tip axis is aligned to be parallel with the tangent to the trajectory at the point of maximum force during the entry phase.

In some embodiments the tooth tip axis is aligned to be parallel with the tangent to the trajectory at the point during the trajectory where the power expended on that tooth's motion is at a maximum.

In some embodiments, the indentation angle γ may be different from tooth to tooth on the same row. This allows for any possible combination of γ₁ and γ₂ on the same row.

In a further class of embodiments, the beta and gamma values can be varied independently, so that more that two types of teeth are present on a row. For example, in one embodiment teeth having (beta,gamma) values of (β₁,γ₁) and (β₂,γ₂) are alternated, whereas in another embodiment successive teeth might have values of (β₁,γ₁), (β₁,γ₂), (β₂,γ₂), (β₂,Y₁), etc., repeating e.g., in a group of 4. Many other variations are also possible.

Optionally, the tooth trajectory can be simulated for multiple passes of a given tooth through the formation, and the above optimizations can be performed with respect to maximum force values, OR with respect to an average over multiple passes.

What is claimed is:

1. A method for designing a roller-cone earth-penetrating drill bit, comprising the actions of:
simulating the unconstrained motion of cones of a roller-cone earth-penetrating drill bit, including the trajectories of teeth thereof through rock being drilled;
and, for multiple respective ones of said teeth, both adjusting a respective crest orientation thereof, in accordance with the general direction of the trajectory of said tooth in a plane normal to the wellbore axis,
and also
adjusting an axis of said tooth in accordance with the angle at which said tooth indents said rock at the start of said trajectory of said tooth.

2. The method of claim 1, wherein the action of simulating the unconstrained motion of cones of a roller-cone earth-penetrating drill bit includes the three-dimensional trajectories of teeth thereof through rock being drilled.

3. The method of claim 1, wherein said bit comprises exactly three of said cones.

4. The method of claim 1, wherein said cones have a bulged frustro-conical shape.

5. The method of claim 1, wherein said teeth are inserts mounted on the bodies of said cones.

6. The method of claim 1, wherein said teeth are formed integrally with the bodies of said cones.

7. The method of claim 1, wherein each of said cones differs from the others.

8. The method of claim 1, wherein said crests are straight.

9. The method of claim 1, wherein said crests have a length which is between one-third and two-thirds of the width of a tooth.

10. The method of claim 1, wherein said tooth is symmetric about an axis, and said adjusting step changes said axis.

11. The method of claim 1, wherein said tooth has a tip portion which is symmetric about a first axis, and has a root portion which is not symmetric about said first axis, and said adjusting step changes said first axis.

12. The method of claim 1, wherein said tooth has a tip portion which is symmetric about a first axis, and has a root portion which is symmetric about a second axis, and said adjusting step changes said first axis.

13. The method of claim 1, wherein said crest of at least one tooth intersects said axis thereof.

14. The method of claim 1, wherein said crest of at least one tooth does not intersect said axis thereof.

15. The method of claim 1, wherein said crest of at least one tooth is perpendicular to said axis thereof.

16. The method of claim 1, wherein the angle of the axis varies for the teeth on a single row.

17. A method for designing a roller-cone earth-penetrating drill bit, comprising the actions of:
fully simulating the motion of a roller-cone earth-penetrating drill bit, including the unconstrained rotation of cones thereof, and the trajectories of teeth supported by said cones through rock being drilled;
and, for multiple respective ones of said teeth, both adjusting a respective crest orientation thereof, and also adjusting an axis of said tooth in accordance with the angle at which said tooth indents said rock at the start of said trajectory of said tooth.

18. The method of claim 17, wherein two axes of said tooth are adjusted.

19. The method of claim 17, wherein said bit comprises exactly three of said cones.

20. The method of claim 17, wherein said teeth are inserts mounted on the bodies of said cones.

21. The method of claim 17, wherein said teeth are formed integrally with the bodies of said cones.

22. The method of claim 17, wherein said crests are straight.

23. The method of claim 17, wherein said crests have a length which is between one-third and two-thirds of the width of a tooth.

24. The method of claim 17, wherein said tooth is symmetric about an axis, and said adjusting step changes said axis.

25. The method of claim 17, wherein said tooth has a tip portion which is symmetric about a first axis, and has a root portion which is not symmetric about said first axis, and said adjusting step changes said first axis.

26. The method of claim 17, wherein said crest of at least one tooth intersects said axis thereof.

27. The method of claim 17, wherein said crest of at least one tooth does not intersect said axis thereof.

28. The method of claim 17, wherein the angle of the axis varies for the teeth on a single row.

29. A method for designing a roller-cone earth-penetrating drill bit, comprising the actions of:
simulating the trajectories of teeth supported by cones of said drill bit through rock under drilling conditions;
and, for multiple respective ones of said teeth, adjusting at least two different orientation angles thereof,
said orientation angles being different from parameters which define the characteristics of the respective tooth, and different from parameters which define the location of the respective tooth on the surface of the cone.

30. The method of claim 29, wherein at least three different orientation angles are adjusted.

31. The method of claim 29, wherein said bit comprises exactly three of said cones.

32. The method of claim 29, wherein said teeth are inserts mounted on the bodies of said cones.

33. The method of claim 29, wherein said teeth are formed integrally with the bodies of said cones.

34. The method of claim 29, wherein said crests are straight.

35. The method of claim 29, wherein said crests have a length which is between one-third and two-thirds of the width of a tooth.

36. The method of claim 29, wherein said tooth is symmetric about an axis, and said adjusting step changes said axis.

37. The method of claim 29, wherein said tooth has a tip portion which is symmetric about a first axis, and has a root portion which is not symmetric about said first axis, and said adjusting step changes said first axis.

38. The method of claim 29, wherein said crest of at least one tooth intersects said axis thereof.

39. The method of claim 29, wherein said crest of at least one tooth does not intersect said axis thereof.

40. The method of claim 29, wherein the angle of the axis varies for the teeth on a single row.

41. A method for designing a roller-cone earth-penetrating drill bit, comprising the actions of:
simulating the unconstrained motion of cones of a roller-cone earth-penetrating drill bit, including the three-dimensional trajectories of teeth thereof through rock being drilled;
and, for at least one of said teeth, adjusting an axis of said tooth in accordance with the direction at which said tooth indents said rock at the start of said trajectory.

42. The method of claim 41, wherein said axis of said tooth is adjusted in accordance with the three-dimensional vector at which said tooth indents said rock at the start of said trajectory.

43. The method of claim 41, wherein said bit comprises exactly three of said cones.

44. The method of claim 41, wherein said teeth are inserts mounted on the bodies of said cones.

45. The method of claim 41, wherein said teeth are formed integrally with the bodies of said cones.

46. The method of claim 41, wherein said crests are straight.

47. The method of claim 41, wherein said crests have a length which is between one-third and two-thirds of the width of a tooth.

48. The method of claim 41, wherein said tooth is symmetric about an axis, and said adjusting step changes said axis.

49. The method of claim 41, wherein said tooth has a tip portion which is symmetric about a first axis, and has a root portion which is not symmetric about said first axis, and said adjusting step changes said first axis.

50. The method of claim 41, wherein said crest of at least one tooth intersects said axis thereof.

51. The method of claim 41, wherein said crest of at least one tooth does not intersect said axis thereof.

52. The method of claim 41, wherein the angle of the axis varies for the teeth on a single row.

53. A method for designing a roller-cone earth-penetrating drill bit, comprising the actions of:
simulating the unconstrained motion of cones of a roller-cone earth-penetrating drill bit, including the three-dimensional trajectories of teeth thereof through rock being drilled;
and, for at least one of said teeth, adjusting the orientation of the crest of said tooth; and
adjusting the orientation of the top part of said tooth, in dependence on said trajectory.

54. The method of claim 53, wherein said crest length is adjusted with respect to the scraping direction of said teeth through rock being drilled, and the top part is adjusted with respect to the indentation direction of said teeth through rock being drilled.

55. The method of claim 53, wherein said crest length is adjusted to be perpendicular to the scraping direction of said teeth through rock being drilled, and the top part is adjusted to follow the indentation direction of said teeth through rock being drilled.

56. The method of claim 53, wherein said bit comprises exactly three of said cones.

57. The method of claim 53, wherein said teeth are inserts mounted on the bodies of said cones.

58. The method of claim 53, wherein said teeth are formed integrally with the bodies of said cones.

59. The method of claim 53, wherein said crests are straight.

60. The method of claim 53, wherein said crests have a length which is between one-third and two-thirds of the width of a tooth.

61. The method of claim 53, wherein said tooth is symmetric about an axis, and said adjusting step changes said axis.

62. The method of claim 53, wherein said tooth has a tip portion which is symmetric about a first axis, and has a root portion which is not symmetric about said first axis, and said adjusting step changes said first axis.

63. The method of claim 53, wherein said crest of at least one tooth intersects said axis thereof.

64. The method of claim 53, wherein said crest of at least one tooth does not intersect said axis thereof.

65. The method of claim 53, wherein the angle of the axis varies for the teeth on a single row.

66. A method for designing a roller-cone earth-penetrating drill bit, comprising the actions of:
simulating the unconstrained motion of cones of a roller-cone earth-penetrating drill bit, including the three-dimensional trajectories of teeth thereof through rock being drilled;
and, for at least one of said teeth, determining the indentation angle for said teeth, in dependence on said trajectory; and
orientating the top part of said tooth with respect to the indentation angle.

67. The method of claim 66, wherein said bit comprises exactly three of said cones.

68. The method of claim 66, wherein said teeth are inserts mounted on the bodies of said cones.

69. The method of claim 66, wherein said teeth are formed integrally with the bodies of said cones.

70. The method of claim 66, wherein said crests are straight.

71. The method of claim 66, wherein said crests have a length which is between one-third and two-thirds of the width of a tooth.

72. The method of claim 66, wherein said tooth is symmetric about an axis, and said adjusting step changes said axis.

73. The method of claim 66, wherein said tooth has a tip portion which is symmetric about a first axis, and has a root portion which is not symmetric about said first axis, and said adjusting step changes said first axis.

74. The method of claim 66, wherein said crest of at least one tooth intersects said axis thereof.

75. The method of claim 66, wherein said crest of at least one tooth does not intersect said axis thereof.

76. The method of claim 66, wherein the angle of the axis varies for the teeth on a single row.

77. A method for designing a roller-cone earth-penetrating drill bit, comprising the actions of:
simulating the unconstrained motion of cones of a roller-cone earth-penetrating drill bit, including the three-dimensional trajectories of teeth thereof through rock being drilled;
and, for at least one of said teeth, adjusting said teeth, in dependence on said trajectory; such that the normal of the surface of said teeth is in line with the penetration direction of said teeth through rock being drilled.

78. The method of claim 77, wherein said bit comprises exactly three of said cones.

79. The method of claim 77, wherein said teeth are inserts mounted on the bodies of said cones.

80. The method of claim 77, wherein said teeth are formed integrally with the bodies of said cones.

81. The method of claim 77, wherein said crests are straight.

82. The method of claim 77, wherein said crests have a length which is between one-third and two-thirds of the width of a tooth.

83. The method of claim 77, wherein said tooth is symmetric about an axis, and said adjusting step changes said axis.

84. The method of claim 77, wherein said tooth has a tip portion which is symmetric about a first axis, and has a root portion which is not symmetric about said first axis, and said adjusting step changes said first axis.

85. The method of claim 77, wherein said crest of at least one tooth intersects said axis thereof.

86. The method of claim 77, wherein said crest of at least one tooth does not intersect said axis thereof.

87. The method of claim 77, wherein the angle of the axis varies for the teeth on a single row.

88. A roller-cone earth-penetrating drill bit comprising:
one or more teeth, wherein the crest length is perpendicular to the scraping direction of said teeth through rock being drilled, and the top part follows the indentation direction of said teeth through rock being drilled.

89. The roller of claim 88, wherein the angle of the axis varies for the teeth on a single row.

90. A roller-cone earth-penetrating drill bit comprising:
one or more teeth, wherein the normal of the surface of said teeth when said respective teeth first contacts cutting face is in line with the penetration direction of said teeth through rock being drilled.

91. The roller of claim 90, wherein the angle of the axis varies for the teeth on a single row.

92. A roller-cone earth-penetrating drill bit comprising:
one or more teeth with an axis adjusted in accordance with the trajectory of said respective teeth onto a cutting surface.

93. The roller of claim 92, wherein the angle of the axis varies for the teeth on a single row.

94. A roller-cone earth-penetrating drill bit comprising:
one or more teeth with an axis adjusted in accordance with an angle at which said respective teeth penetrates through a cutting surface into a volume of material therebeneath.

95. The roller of claim 94, wherein the angle of the axis varies for the teeth on a single row.

96. A roller-cone earth-penetrating drill bit comprising:
one or more teeth with the crests and the top parts of said respective teeth adjusted in dependence on a three-dimensional trajectory of said respective teeth through formation being drilled.

97. The roller of claim 96, wherein the angle of the axis varies for the teeth on a single row.

98. A roller cone bit designed by the method of claim 1.

99. A roller cone bit designed by the method of claim 17.

100. A roller cone bit designed by the method of claim 29.

101. A roller cone bit designed by the method of claim 41.

102. A roller cone bit designed by the method of claim 53.

103. A roller cone bit designed by the method of claim 66.

104. A roller cone bit designed by the method of claim 77.
